(19) United States
(12) Patent Application Publication
(10) Pub. No.: US 2024/0363110 A1
(43) Pub. Date: Oct. 31, 2024

(54) ELECTRONIC DEVICE, METHOD, SYSTEM, MEDIUM, AND PROGRAM CAPABLE OF VOICE CONTROL

(71) Applicant: ARRIS Enterprises LLC, Horsham, PA (US)

(72) Inventors: Qi WANG, Shanghai (CN); Wan Ting YANG, Shanghai (CN); Luyan SUN, Shanghai (CN); Min WEI, Shanghai (CN)

(21) Appl. No.: 18/577,048

(22) PCT Filed: Jun. 8, 2022
(86) PCT No.: PCT/US2022/032635

§ 371 Date: Jan. 5, 2024

(30) Foreign Application Priority Data
Jul. 7, 2021 (CN) 202110766091.X

(51) Int. Cl. G10L 15/22; G10L 15/02; G10L 15/30; G10L 21/0208; G10L 21/034; G10L 21/0364

(52) U.S. Cl. CPC G10L 15/22; G10L 15/02; G10L 15/30; G10L 2015/025; G10L 2015/223; G10L 21/0208; G10L 21/034; G10L 21/0364

(57) ABSTRACT

The present disclosure relates to an electronic device, a method, a system, a medium, and a program capable of voice control. The electronic device includes: a memory having instructions stored thereof; and a processor configured to execute the instructions stored on the memory to cause the electronic device to carry out the following operations: receive the user's voice detected by the detector from at least one terminal device among a plurality of terminal devices equipped with detectors; perform voice recognition processing on the received user's voice to obtain the command contained in the user's voice; and analyze the command, and in the case where the command only contains a control command and does not contain a specific terminal device name, determine the sound intensity of the control command, and in the case where the sound intensity of the control command is higher than a predetermined threshold, instruct the terminal device from which the control command with a sound intensity higher than the predetermined threshold is received to execute the control command.

### TECHNICAL FIELD

The present disclosure relates to the field of voice control, and in particular to an electronic device, a method, a system, a medium, and a program capable of voice control.

### BACKGROUND ART

Presently, voice-controlled home facilities (for example, voice-controlled lights, background music volume, curtains, etc.) have become more and more popular through multiple Mic sensors installed all over the home. In terms of voice-controlled home facilities, how to distinguish which device is the target device for voice control is a key issue.

The traditional method is to tag each device, and the user controls the device by saying “device name+control command.” For example, “turn off the lights in the kitchen,” “decrease the volume of the speakers in the study room,” “close the curtains in bedroom 1,” etc. As the user needs to clearly remember the name of the device, when the user is old or the number of devices is large, it will cause confusion and lead to poor user experience.

Therefore, it is desirable to provide an improved voice control method compatible with existing voice control methods, so as to improve user experience.

### SUMMARY OF THE INVENTION

The present disclosure provides an electronic device, a method, a system, a medium, and a program capable of voice control, so that the user can control a specific device through “device name+control command,” or control at least one target device through a single simple command, thereby improving user experience.

Some aspects of the present disclosure relate to an electronic device capable of voice control. The electronic device comprises: a memory device having instructions stored thereon; and a processor configured to execute the instructions stored on the memory to cause the electronic device to carry out the following operations: receive the user's voice detected by the detector from at least one terminal device among a plurality of terminal devices equipped with detectors; perform voice recognition processing on the received user's voice to obtain the command contained in the user's voice; and analyze the command, and in the case where the command only contains a control command and does not contain a specific terminal device name, determine the sound intensity of the control command, and in the case where the sound intensity of the control command is higher than a predetermined threshold, instruct the terminal device from which the control command with a sound intensity higher than the predetermined threshold is received to execute the control command.

In some embodiments, performing voice recognition processing on the received user's voice to obtain the command contained in the user's voice further includes: creating a waveform file of the user's voice; filtering the waveform file by removing background noise and normalizing the volume; breaking down the filtered waveform file into a plurality of phonemes; and inferring words and entire sentences by sequentially analyzing the plurality of phonemes using statistical probability, thereby obtaining the command contained in the user's voice.

In some embodiments, the processor is further configured to execute the instructions stored on the memory to cause the electronic device to carry out the following operations: analyze the command, and in the case where the command contains a specific terminal device name and a control command, instruct the specific terminal device to execute the control command.

In some embodiments, in the case where the specific terminal device is a remote terminal device, the at least one terminal device is used as a repeater to transmit the command to the electronic device.

Other aspects of the present disclosure relate to a voice control method executed by the electronic device. The method includes: receiving the user's voice detected by the detector from at least one terminal device among a plurality of terminal devices equipped with detectors; performing voice recognition processing on the received user's voice to obtain the command contained in the user's voice; and analyzing the command, and in the case where the command only contains a control command and does not contain a specific terminal device name, determining the sound intensity of the control command, and in the case where the sound intensity of the control command is higher than a predetermined threshold, instructing the terminal device from which the control command with a sound intensity higher than the predetermined threshold is received to execute the control command.

In some embodiments, performing voice recognition processing on the received user's voice to obtain the command contained in the user's voice further includes: creating a waveform file of the user's voice; filtering the waveform file by removing background noise and normalizing the volume; breaking down the filtered waveform file into a plurality of phonemes; and inferring words and entire sentences by sequentially analyzing the plurality of phonemes using statistical probability, thereby obtaining the command contained in the user's voice.

In some embodiments, the method further includes: analyzing the command, and in the case where the command contains a specific terminal device name and a control command, instructing the specific terminal device to execute the control command.

In some embodiments, in the case where the specific terminal device is a remote terminal device, the at least one terminal device is used as a repeater to transmit the command to the electronic device.

Other aspects of the present disclosure relate to a voice control system. The system comprises: a plurality of terminal devices equipped with detectors capable of detecting the user's voice, and a server connected to the plurality of terminal devices equipped with detectors; wherein each terminal device among the plurality of terminal devices equipped with detectors is configured to send the detected user's voice to the server after the detector detects the user's voice, and wherein the server is configured to: receive the user's voice detected by the detector from at least one terminal device among a plurality of terminal devices equipped with detectors; perform voice recognition processing on the received user's voice to obtain the command contained in the user's voice; and analyze the command, and in the case where the command only contains a control command and does not contain a specific terminal device name, determine the sound intensity of the control command, and in the case where the sound intensity of the control command is higher than a predetermined threshold, instruct the terminal device from which the control command with a sound intensity higher than the predetermined threshold is received to execute the control command.

In some embodiments, performing voice recognition processing on the received user's voice to obtain the command contained in the user's voice further includes: creating a waveform file of the user's voice; filtering the waveform file by removing background noise and normalizing the volume; breaking down the filtered waveform file into a plurality of phonemes; and inferring words and entire sentences by sequentially analyzing the plurality of phonemes using statistical probability, thereby obtaining the command contained in the user's voice.

In some embodiments, the server is further configured to: analyze the command, and in the case where the command contains a specific terminal device name and a control command, instruct the specific terminal device to execute the control command.

In some embodiments, in the case where the specific terminal device is a remote terminal device, the at least one terminal device is used as a repeater to transmit the command to the server.

Other aspects of the present disclosure relate to a non-transitory computer-readable medium which has an instruction stored thereon to be executed by a processor so as to execute the steps of the voice control method described above.

Other aspects of the present disclosure relate to a computer program product including a computer program, when executed by a processor, the computer program executing the steps of the voice control method described above.

### BRIEF DESCRIPTION OF THE ATTACHED DRAWINGS

For a better understanding of the present disclosure and to show how to implement the present disclosure, examples are herein described with reference to the attached drawings, wherein:

FIG. 1 is a schematic diagram showing an example network environment including a network access device according to an embodiment of the present disclosure;

FIG. 2 shows an exemplary configuration block diagram of an electronic device capable of voice control according to an embodiment of the present disclosure;

FIG. 3 shows an exemplary flowchart of a voice control method according to an embodiment of the present disclosure.

It should be noted that throughout the attached drawings, similar reference numerals and signs refer to corresponding parts.

### SPECIFIC EMBODIMENTS

The following detailed description is made with reference to the attached drawings, and the following detailed description is provided to facilitate comprehensive understanding of various exemplary embodiments of the present disclosure. The following description includes various details for facilitation of understanding. However, these details are merely considered as examples, not for limiting the present disclosure. The present disclosure is defined by the attached Claims and their equivalents. The words and phrases used in the following description are only used to enable a clear and consistent understanding of the present disclosure. In addition, for clarity and brevity, descriptions of well-known structures, functions, and configurations may be omitted. Those of ordinary skill in the art will realize that various changes and modifications can be made to the examples described in the present specification without departing from the gist and scope of the present disclosure.

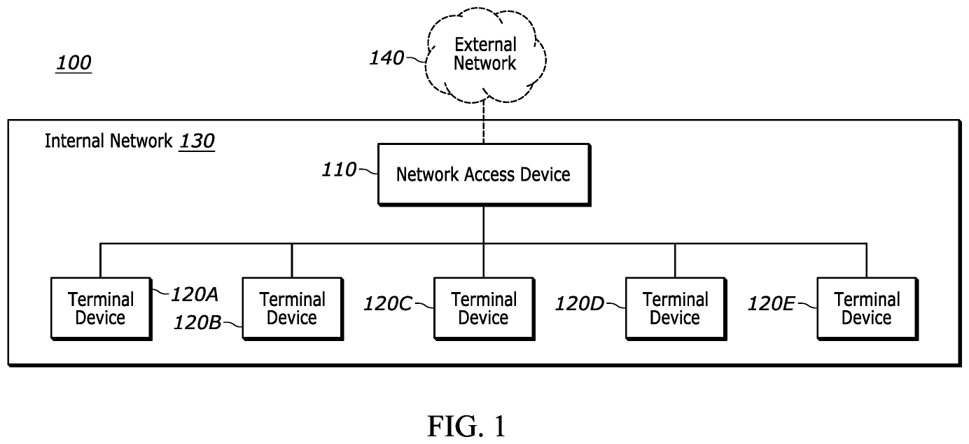

FIG. 1 is a schematic diagram showing an example network environment 100 including a network access device according to an embodiment of the present disclosure.

The example network environment 100 may include a network access device 110 and one or more terminal devices 120A, 120B, 120C, 120D, and 120E (hereinafter collectively referred to as terminal device 120 for convenience). The network access device 110 is used to provide a network connection for the terminal device 120. Specifically, the network access device 110 may receive/route various types of communications from the terminal device 120 and/or transmit/route various types of communications to the terminal device 120. In some embodiments, the network access device 110 only provides an internal network 130 (for example, wired or wireless local area network (LAN)) connection for the terminal device 120, and all terminal devices 120 connected to the network access device 110 are in the same internal network and can directly communicate with each other. In a further embodiment, the network access device 110 is further connected to an external network 140, via which, the terminal device 120 can access the external network 140. The network access device 110 may be, for example, a hardware electronic device which combines the functions of a network access server (NAS), a modem, a router, a layer 2/layer 3 switch, an access point, etc. The network access device 110 may further comprise, but is not limited to, a function of an IP/QAM set top box (STB) or a smart media device (SMD), and the IP/QAM set top box (STB) or the smart media device (SMD) can decode audio/video content and play content provided by over-the-top (OTT) suppliers or multi-system operators (MSO).

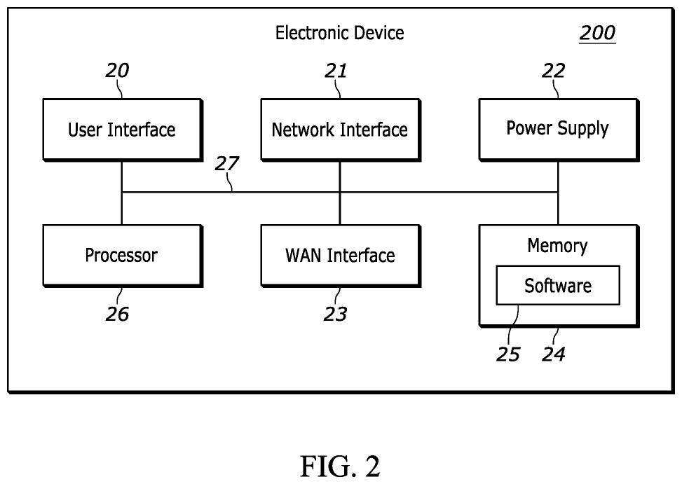

In some embodiments, the terminal device 120 may be any electronic device having at least one network interface. For example, the terminal device 120 may be: a desktop computer, a laptop computer, a server, a mainframe computer, a cloud-based computer, a tablet computer, a smart phone, a smart watch, a wearable device, a consumer electronic device, a portable computing device, a radio node, a router, a switch, a repeater, an access point and/or other electronic devices. As described in detail below with reference to FIG. 2, the terminal device 120 communicates with a physical or virtual network interface of the network access device 110 using its network interface, thereby accessing the internal network 130 via the network access device 110. A plurality of terminal devices 120A, 120B, 120C, 120D, and 120E may be connected to the same or different network interfaces of the network access device 110. Although five terminal devices are shown in FIG. 1, it should be understood that the number of terminal devices that can be connected to the network access device may be less than or more than five, depending on the number of specific physical interfaces and/or network capacity supported by the network access device.

The external network 140 may include various types of wired or wireless networks, internal networks or public networks, for example, other local area networks or wide area networks (WAN) (such as the Internet). It should be noted that the present disclosure does not specifically define the type of the external network 140.

FIG. 2 illustrates an exemplary configuration block diagram of an electronic device 200 capable of voice control according to an embodiment of the present disclosure. According to a preferred embodiment of the present disclosure, the electronic device 200 may be a central controller or server integrated in the network access device 110 shown in FIG. 1.

As shown in FIG. 2, the electronic device 200 includes a user interface 20, a network interface 21, a power source 22, an external network interface 23, a memory 24, and a processor 26. The user interface 20 may include, but is not limited to, a button, a keyboard, a keypad, LCD, CRT, TFT, LED, HD or other similar display devices, including a display device with a touch screen capability that enables interaction between a user and a gateway device. In some embodiments, the user interface 20 may be used to present a graphical user interface (GUI) to receive user input.

The network interface 21 may include various network cards and a circuit system enabled by software and/or hardware so as to be able to communicate with a user device using wired or wireless protocols. The wired communication protocol is, for example, any one or more of the Ethernet protocol, the MoCA specification protocol, the USB protocol, or other wired communication protocols. The wireless protocol is, for example, any IEEE 802.11 Wi-Fi protocol, Bluetooth protocol, Bluetooth Low Energy (BLE) or other short-distance protocols operated in accordance with wireless technology standards, and is used for utilization of any licensed or unlicensed frequency band (for example, the Citizen Broadband Radio Service (CBRS) band, 2.4 GHz band, 5 GHz band, 6 GHz band, or 60 GHz band), RF4CE protocol, ZigBee protocol, Z-Wave protocol, or IEEE 802.15.4 protocol to exchange data over a short distance. When the network interface 21 uses a wireless protocol, in some embodiments, the network interface 21 may further include one or more antennas (not shown) or a circuit node to be coupled to one or more antennas. The electronic device 200 may provide an internal network (for example, the internal network 130 in FIG. 1) to the user device through the network interface 21.

The power source 22 provides power to internal components of the electronic device 200 through an internal bus 27. The power source 22 may be a self-contained power source such as a battery pack, the interface of which is powered by (for example, directly or through other devices) a charger connected to a socket. The power source 22 may further include a rechargeable battery that is detachable for replacement, for example, NiCd, NiMH, Li-ion, or Li-pol battery. The external network interface 23 may include various network cards and a circuit system enabled by software and/or hardware so as to achieve communication between the electronic device 200 and a provider (for example, an Internet service provider or a multi-system operator (MSO)) of an external network (for example, the external network 140 in FIG. 1).

The memory 24 includes a single memory or one or more memories or storage locations, including but not limited to a random access memory (RAM), a dynamic random access memory (DRAM), a static random access memory (SRAM), a read-only memory (ROM), EPROM, EEPROM, a flash memory, FPGA logic block, a hard disk, or any other layers of a memory hierarchy. The memory 24 may be used to store any type of instructions, software or algorithms, including software 25 for controlling general functions and operations of the electronic device 200.

The processor 26 controls general operations of the electronic device 200 and executes management functions related to other devices (such as a user device) in the network. The processor 26 may include, but is not limited to, a CPU, a hardware microprocessor, a hardware processor, a multi-core processor, a single-core processor, a microcontroller, an application-specific integrated circuit (ASIC), a DSP, or other similar processing devices, which can execute any type of instructions, algorithms, or software for controlling the operations and functions of the electronic device 200 according to the embodiments described in the present disclosure. The processor 26 may be various realizations of a digital circuit system, an analog circuit system, or a mixed signal (combination of analog and digital) circuit system that executes functions in a computing system. The processor 26 may include, for example, an integrated circuit (IC), a part or circuit of a separate processor core, an entire processor core, a separate processor, a programmable hardware device such as a field programmable gate array (FPGA), and/or a system including a plurality of processors.

The internal bus 27 may be used to establish communication between the components of the electronic device 200 (for example, 20 to 22, 24 and 26).

Although specific components are used to describe the electronic device 200, in an alternative embodiment, there may be different components in the electronic device 200. For example, the electronic device 200 may include one or more additional controllers, memories, network interfaces, external network interfaces and/or user interfaces. In addition, one or more of the components may not exist in the electronic device 200. Moreover, in some embodiments, the electronic device 200 may include one or more components not shown in FIG. 2. In addition, although separate components are shown in FIG. 2, in some embodiments, some or all of the given components may be integrated into one or more of the other components in the electronic device 200. Moreover, any combination of analog and/or digital circuits may be used to realize the circuit and components in the electronic device 200.

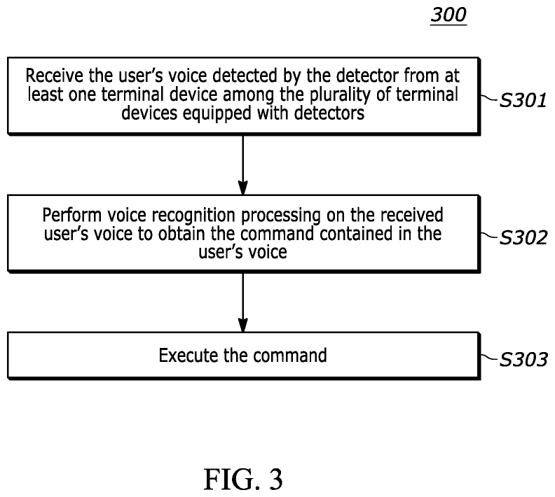

FIG. 3 shows a flowchart of an exemplary method 300 for voice control according to an embodiment of the present disclosure. The method 300 may be executed by, for example, the electronic device 200 shown in FIG. 2, and according to a preferred embodiment of the present disclosure, the electronic device 200 may be a central controller or a server integrated in the network access device as shown in FIG. 1. The electronic device and the method used for the electronic device according to embodiments of the present disclosure will be described in detail below, with reference to FIG. 1 to FIG. 3.

As shown in FIG. 3, at step S301, the user's voice detected by the detector is received from at least one terminal device among a plurality of terminal devices equipped with detectors. The terminal device here may be, for example, the terminal device shown in FIG. 1, and each terminal device is equipped with a detector capable of detecting the user's voice, such as a sensor. The network access device and plurality of terminal devices in FIG. 1 form an intelligent IoT control system. For example, the network access device can be a set-top box or a router, and the plurality of terminal devices can be TVs, air conditioners, notebooks, iPads, mobile phones, desk lamps, stereos, curtains, etc. Each terminal device detects the user's voice in real time through the sensor, and sends it to the central controller in the set-top box or router thereafter.

At step S302, voice recognition processing is performed on the received user's voice to obtain the command contained in the user's voice. Voice recognition technology is a crossover technology that has achieved mature development, and the fields involved include signal processing, pattern recognition, probability theory and information theory, sound production mechanism and hearing mechanism, artificial intelligence, etc., which will not be elaborated herein.

According to a preferred embodiment of the present disclosure, performing voice recognition processing on the received user's voice includes creating a waveform file of the user's voice, filtering the waveform file by removing background noise and normalizing the volume, and breaking down the filtered waveform file into a plurality of individual phonemes. Here, phoneme is the basic building block of language and words, and is the smallest phonetic unit divided according to the natural attributes of speech. From the perspective of acoustic properties, phoneme is the smallest phonetic unit divided from the perspective of sound quality; from the perspective of physiological properties, a pronunciation action forms a phoneme. Different languages have different phonemes, and this is not elaborated herein. Performing voice recognition processing on the received user's voice further includes inferring words and entire sentences by sequentially analyzing the plurality of phonemes using statistical probability, thereby obtaining the command contained in the user's voice. For example, based on the first phoneme of a word, a combination of statistical probability (usually a hidden Markov model) and context is used to narrow the range of options and find the spoken word, and then the entire sentence is inferred by analyzing the order of a plurality of phonemes.

At step S303, the command is executed. According to an embodiment of the present disclosure, when the command contains a specific terminal device name and a control command, executing the command is to instruct the specific terminal device to execute the control command.

For example, after receiving a command to “close the curtains in the living room” from the iPhone held by the user, the curtains in the living room are instructed to close automatically. On the one hand, this makes it perfectly compatible with the traditional method of “device name+control command,” and on the other hand, this enables voice control to be performed remotely. For example, in an exemplary embodiment, in a large four-story house, the user is located in the bedroom on the fourth floor and is not sure whether the TV in the living room on the first floor is turned off. At this time, a voice command of “turn off the TV in the living room on the first floor” may be given. The detector installed on the device in the user's room, for example, desktop computer, curtains, etc., detects the user's voice of “turn off the TV in the living room on the first floor” and sends the detected user's voice of “turn off the TV in the living room on the first floor” to the central controller in the network access device (for example, router or set-top box), and then the central controller instructs the TV in the living room on the first floor to turn off by itself, so that the user does not have to specially run from the fourth floor to the first floor to confirm whether the TV is turned off or to specially go to the first floor to turn off the TV. Furthermore, in this case, the connection between the desktop computer or the curtains as the repeater and the central controller is wired, and the voice command is not attenuated in the process of transmission to the central controller.

According to another embodiment of the present disclosure, when the command only contains a control command and does not contain a specific terminal device name, executing the command includes analyzing the sound intensity of the control command, and in the case where the sound intensity of the control command is higher than a predetermined threshold, instructing the terminal device from which the control command with a sound intensity higher than the predetermined threshold is received, to execute the control command. It should be understood that the predetermined threshold may be set and/or adjusted according to actual conditions (for example, environment, etc.).

For example, according to an exemplary embodiment, when a user located in the living room gives a voice command of “decrease volume,” the terminal devices around the user (for example, a mobile phone that is playing video in the hands of another person in the living room; a TV that is playing in the living room; a notebook that is playing an online course in a room close to the living room, with the room door open) detect the voice, and each device sends the voice to the central controller. The central controller obtains the command “decrease volume” from the voices received from the mobile phone, TV, and notebook, respectively through voice recognition processing. Since the command only contains a control command without any specific device name, the central controller analyzes the sound intensity of the control command “decrease volume” received from the aforementioned mobile phone, TV, and notebook, respectively and compares the sound intensity of each voice with the volume threshold. For example, suppose that the volume threshold (in dB) is set to Thr, and the sound intensity of the control commands received from the mobile phone and TV is greater than Thr, while the sound intensity of the control command received from the notebook is less than Thr, then the central controller will instruct the aforementioned mobile phone and TV to lower the volume, while keeping the volume of the notebook unadjusted.

In another exemplary embodiment, based on the same principle, after setting an appropriate volume threshold Thr, a user watching a football game in the living room late at night can turn on the lights in the living room by giving a voice command of “turn on lights,” without disturbing the family members who sleep in the next room.

This is a fuzzy personalized control, which helps to distinguish the needs of family members in different rooms/areas, thereby improving user experience. For example, the aforementioned voice control of decrease volume/turn on lights not only meets the needs of the user who gave the command of decrease volume/turn on lights in his/her own environment, but also ensures that the users in the room are not affected by the command given, i.e., the notebook in the room continues playing the online course at the original volume/the lights in the room are not turned on, so as not to affect the user experience of users in the room.

Through the aforementioned electronic device capable of voice control, users can not only accurately control (including remote control) specific devices in the IoT system, but also control at least one device through a single simple command based on sound intensity detection, thereby improving user experience, especially when the device name is complicated or control or more than one device needs to be controlled at the same time.

The present disclosure may be implemented as any combination of devices, systems, integrated circuits, and computer programs on non-transitory computer-readable media, and can be applied to existing home IoT systems. One or more processors may be enabled as an Integrated Circuit (IC), an Application Specific Integrated Circuit (ASIC) or a Large-scale Integrated Circuit (LSI), a system LSI, a super LSI, or an ultra LSI component that performs part or all of the functions described in the present disclosure.

The present disclosure includes the use of software, applications, computer programs, or algorithms. Software, application programs, computer programs or algorithms can be stored on a non-transitory computer-readable medium, so that a computer with one or a plurality of processors can execute the aforementioned steps and the steps described in the attached drawings. For example, one or more memories store software or algorithm with executable instructions, and one or more processors can associate with a set of instructions for executing the software or algorithm so as to provide network configuration information management functions of network access devices according to the embodiments described in the present disclosure.

Software and computer programs (also called programs, software applications, applications, components, or codes) include machine instructions for programmable processors, and may be realized in high-level procedural languages, object-oriented programming languages, functional programming languages, logic programming languages, or assembly languages or machine languages. The term “computer-readable medium” refers to any computer program product, apparatus or device used to provide machine instructions or data to the programmable data processor, e.g., magnetic disks, optical disks, solid-state storage devices, memories, and programmable logic devices (PLDs), including computer-readable media that receive machine instructions as computer-readable signals.

For example, the computer-readable medium may include the dynamic random access memory (DRAM), random access memory (RAM), read only memory (ROM), electrically erasable read only memory (EEPROM), compact disk read only memory (CD-ROM) or other optical disk storage devices, magnetic disk storage devices or other magnetic storage devices, or any other medium that can be used to carry or store the required computer-readable program codes in the form of instructions or data structures and can be accessed by a general or special computer or a general or special processor. As used herein, magnetic disks or disks include Compact Discs (CDs), laser disks, optical disks, Digital Versatile Discs (DVDs), floppy disks, and Blu-ray disks, wherein magnetic disks usually copy data magnetically, and disks copy data optically via laser. Combinations of the above are also included in the scope of computer-readable media.

In addition, the above description provides examples without limiting the scope, applicability, or configuration set forth in the claims. Without departing from the spirit and scope of the present disclosure, changes may be made to the functions and layouts of the discussed components. Various embodiments may omit, substitute, or add various processes or components as appropriate. For example, features described with respect to some embodiments may be combined in other embodiments.

1. An electronic device capable of voice control, including:
a memory having instructions stored thereon; and
a processor configured to execute the instructions stored on the memory to cause the electronic device to carry out the following operations:
receive the user's voice detected by the detector from at least one terminal device among a plurality of terminal devices equipped with detectors;
perform voice recognition processing on the received user's voice to obtain the command contained in the user's voice; and
analyze the command, and in the case where the command only contains a control command and does not contain a specific terminal device name, determine the sound intensity of the control command, and in the case where the sound intensity of the control command is higher than a predetermined threshold, instruct the terminal device from which the control command with a sound intensity higher than the predetermined threshold is received to execute the control command.

2. The electronic device according to claim 1, wherein performing voice recognition processing on the received user's voice to obtain the command contained in the user's voice further includes:
creating a waveform file of the user's voice;
filtering the waveform file by removing background noise and normalizing the volume;
breaking down the filtered waveform file into a plurality of phonemes; and
inferring words and entire sentences by sequentially analyzing the plurality of phonemes using statistical probability, thereby obtaining the command contained in the user's voice.

3. The electronic device according to claim 1, wherein the processor is further configured to execute the instructions stored on the memory to cause the electronic device to carry out the following operations:
analyze the command, and in the case where the command contains a specific terminal device name and a control command, instruct the specific terminal device to execute the control command.

4. The electronic device according to claim 3, wherein in the case where the specific terminal device is a remote terminal device, the at least one terminal device is used as a repeater to transmit the command to the electronic device.

5. A voice control method executed by the electronic device, including:
receiving the user's voice detected by the detector from at least one terminal device among a plurality of terminal devices equipped with detectors;
performing voice recognition processing on the received user's voice to obtain the command contained in the user's voice; and
analyzing the command, and in the case where the command only contains a control command and does not contain a specific terminal device name, determining the sound intensity of the control command, and in the case where the sound intensity of the control command is higher than a predetermined threshold, instructing the terminal device from which the control command with a sound intensity higher than the predetermined threshold is received to execute the control command.

6. The voice control method according to claim 5, wherein performing voice recognition processing on the received user's voice to obtain the command contained in the user's voice further includes:
creating a waveform file of the user's voice;
filtering the waveform file by removing background noise and normalizing the volume;
breaking down the filtered waveform file into a plurality of phonemes; and
inferring words and entire sentences by sequentially analyzing the plurality of phonemes using statistical probability, thereby obtaining the command contained in the user's voice.

7. The voice control method according to claim 5, wherein the method further includes:
analyzing the command, and in the case where the command contains a specific terminal device name and a control command, instructing the specific terminal device to execute the control command.

8. The voice control method according to claim 7, wherein in the case where the specific terminal device is a remote terminal device, the at least one terminal device is used as a repeater to transmit the command to the electronic device.

9. A voice control system comprising:
a plurality of terminal devices equipped with detectors that are capable of detecting the user's voice, and
a server connected to the plurality of terminal devices equipped with detectors;
wherein each terminal device among the plurality of terminal devices equipped with detectors is configured to send the detected user's voice to the server after the detector detects the user's voice, and
wherein the server is configured to:
receive the user's voice detected by the detector from at least one terminal device among the plurality of terminal devices equipped with detectors;
perform voice recognition processing on the received user's voice to obtain the command contained in the user's voice; and
analyze the command, and in the case where the command only contains a control command and does not contain a specific terminal device name, determine the sound intensity of the control command, and in the case where the sound intensity of the control command is higher than a predetermined threshold, instruct the terminal device from which the control command with a sound intensity higher than the predetermined threshold is received to execute the control command.

10. The voice control system according to claim 9, wherein performing voice recognition processing on the received user's voice to obtain the command contained in the user's voice further includes:
creating a waveform file of the user's voice;
filtering the waveform file by removing background noise and normalizing the volume;
breaking down the filtered waveform file into a plurality of phonemes; and
inferring words and entire sentences by sequentially analyzing the plurality of phonemes using statistical probability, thereby obtaining the command contained in the user's voice.

11. The voice control system according to claim 9, wherein the server is further configured to:
analyze the command, and in the case where the command contains a specific terminal device name and a control command, instruct the specific terminal device to execute the control command.

12. The voice control system according to claim 9, wherein in the case where the specific terminal device is a remote terminal device, the at least one terminal device is used as a repeater to transmit the command to the server.

13. A non-transitory computer-readable medium, wherein the non-transitory computer-readable medium has instructions stored thereon to be executed by a processor to perform the steps of the method according to claim 5.

14. A computer program product, comprising computer programs that, when executed by a processor, performs the steps of the method according to claim 5.
